(19) United States
(12) Patent Application Publication
(10) Pub. No.: US 2022/0347919 A1
(43) Pub. Date: Nov. 3, 2022

(54) DEVICE AND METHOD FOR ADDITIVE MANUFACTURING

(71) Applicant: ECOLE CENTRALE DE NANTES, NANTES (FR)

(72) Inventors: Jean-Yves HASCOËT, Nantes (FR); Pascal MOGNOL, Rennes (FR); Tugdual LE NÉEL, Nantes (FR)

(21) Appl. No.: 17/624,240

(22) PCT Filed: Jul. 8, 2019
(86) PCT No.: PCT/EP2019/068309

§ 371 Date: Dec. 30, 2021

(30) Foreign Application Priority Data
Jul. 7, 2018 (FR) FR1870816

(51) Int. Cl. B29C 64/241; B33Y 10/00; B33Y 30/00; B33Y 50/00; B28B 1/00; B29C 64/153; B29C 64/386; B29C 64/329; B33Y 40/00; B22F 10/28; B22F 10/80; B22F 12/00; B22F 12/52; B22F 12/67; B29C 64/214

(52) U.S. Cl. CPC B29C 64/241; B33Y 10/00; B33Y 30/00; B33Y 50/00; B28B 1/001; B29C 64/153; B29C 64/386; B29C 64/329; B33Y 40/00; B22F 10/28; B22F 10/80; B22F 12/226; B22F 12/52; B22F 12/67; B29C 64/214

(57) ABSTRACT

A robot to manufacture a part by additive manufacturing using volume elements or voxels. The robot includes a base and a rotary arm having a plurality of effectors for additive manufacturing radially distributed on the arm. A guiding shaft to translationally move the rotary arm by rotation, in a direction parallel to its axis of rotation, and to translationally and rotationally guide the rotary arm relative to the base. A controller to control the action of the effectors for additive manufacturing as a function of the position of the rotary arm in space. A method for implementing the robot is provided.

### TECHNICAL FIELD

The invention pertains a device and a method for additive manufacturing. The invention is adapted to numerous additive manufacturing methods, in particular those implementing a spraying of material, a sintering or a selective melting of material in a material bed, a selective spraying of binder on a material bed.

### BACKGROUND OF THE INVENTION

Additive manufacturing consists of manufacturing a part through a stratification of layers. Each layer corresponds to an addition of material, whatever the method, of determined thickness and shape, on the preceding stratum. This addition of material is done by means of an effector which, according to the additive manufacturing method considered, performs a direct input of material (case of spraying), or reconstitutes solid and cohesive material from a non-cohesive material deposited beforehand. The shape of the layer is obtained by controlling the relative path of the effector during the input of material.

The motion of a tool during a manufacturing by material removal and of an effector during additive manufacturing are similar, such that the means, machine and information systems, used in the field of machining by material removal can be used after a few adaptations for the implementation of an additive manufacturing method.

Actually, according to the biases of a person skilled in the art, additive manufacturing is implemented by means of the same machines or machines which are very similar to those used for machining by material removal, reproducing machine tools kinematics, with serial or parallel kinematics, or using polyarticulated robots.

These kinematic solutions comprise at least 3 controlled axes and most often, 5 or 6 axes, which makes these machines complex to make. In addition, they only allow to move one effector at a time, and even if it is possible to assemble several effectors on the head of a machine tool or at the end of the arm of a robot, those are necessarily following parallel paths.

These solutions of the prior art are also limited by their working volume. A machine tool has a fixed working volume in the same way as a polyarticlated robot, and, if it is possible to associate several polyarticulated robots to cover a greater volume, the programming becomes complex.

### OBJECT AND SUMMARY OF THE INVENTION

The invention aims to solve these disadvantages and to this end, pertains to a robot adapted to the manufacturing of a part by additive manufacturing by volume elements or voxels, said robot comprising:

a base; a rotary arm including a plurality of effectors for additive manufacturing radially distributed on said arm; means for translationally moving the rotary arm while rotating, in a direction parallel to its axis of rotation; means for translationally and rotationally guiding the rotary arm relative to the base; means for controlling the action of the effectors for additive manufacturing as a function of the position of the rotary arm in space.

Thus, for each effector of the arm, the combination of the rotation and the translation of the arm defines, in terms of path, a cylindrical, scanned surface. The actuation of the additive manufacturing effector for a determined time while there are traveling across this scanned surface, produces an elementary volume of material or voxels.

This principle, applied to all additive manufacturing effectors present on the arm, allows to create a voxel matrix in the working volume of the robot.

The part to be manufactured is a subassembly of this voxel matrix. It is obtained by controlling each of the effectors during the helical movement of the rotary arm, so as to only create the voxels corresponding to the part.

Thus, all the effectors are subjected to the same kinematics imposed by the rotary arm, but each effector is activated/deactivated individually to construct the part by an assembly of elementary volumes, such that in practice, all the effectors work at the same time and cooperate to create the volume, although they are all driven by the same device.

Thus, by making all the effectors work at the same time, the device of the invention allows an increased productivity while using kinematics which are simple and easily programmable.

Potentially, any shape can be made in the volume scanned by the rotary arm with a resolution which depends on the dimension of the voxel of material which can be achieved by an effector, on the number of effectors installed on the arm and on the step between the effectors.

The system is adaptable to the production of a small or of a very large part and in its simplest version, the robot of the invention only comprises 2 axes, which can be driven by one single motor, which reduces its manufacturing cost with an equal working volume relative to the solutions of the prior art.

The invention is advantageously implemented according to the embodiments and the variants disclosed below, which are to be considered individually or according to any technically possible combination.

Advantageously, the robot of the invention comprises a plurality of effector-carrying rotary arms. This arrangement allows to increase both the resolution and the productivity of the robot, as well as the distribution of the different functions between the arms.

Thus, according to an exemplary embodiment, adapted to the implementation of a method of additive manufacturing by selective aggregation of a granular material comprised in a material bed, one of the rotary arms comprises a deposition assembly of granular material on the material bed.

Advantageously, the deposition assembly comprises a deposition hopper comprising a plurality of discharge holes. This embodiment of the deposition assembly is particularly compact and adaptable to the robot of the invention for a continuous additive manufacturing.

Advantageously, the robot of the invention comprises a scraper, in the form of a blade or a roller acting on the material bed and driven by a rotary arm. According to a particular embodiment, the scraper is connected to the same arm as the hopper.

According to an embodiment, the robot comprises a part support comprising means for moving the part during manufacture. This embodiment allows to improve both the resolution of the contours and to increase the volume of the parts which can be produced by the robot.

According to one particular embodiment, the robot of the invention comprises means for moving the effectors along a rotary arm. This embodiment allows to increase the resolution of the robot in the manufacturing of parts.

Advantageously, the base comprises means for moving all of the robot in space. This embodiment allows both to increase the volume of the part which can be produced by one single robot, but more advantageously, allows to make several robots cooperate on demand, to produce parts of a very large volume.

The invention also pertains to a method for the additive manufacturing of a part implementing a robot of the invention according to any one of its embodiments, comprising steps of: (i) obtaining a discretized volume of volumetric meshes corresponding to the manufacturing volume of the robot; (ii) inserting the digital model of the part in the volume obtained in step i); (iii) determining the volumetric meshes comprised in the volume of the digital model and delimiting the contours of said model according to a predefined projection tolerance; (iv) making the part by associating with each mesh determined in step iii), an activation of an effector in the corresponding position.

This method is simple to implement both from the standpoint of programming and from controlling the robot during production.

In an embodiment of the method of the invention implementing an additive manufacturing method by selective sintering or agglomeration of a material bed, step iv) comprises the activation of an effector for making the retention means of said material bed.

In an advantageous embodiment of the method of the invention, step iv) comprises the association of several robots mounted on mobile bases and cooperating to increase the manufacturing volume, and step i) comprises the obtaining of the total manufacturing volume of all robots combined.

### BRIEF DESCRIPTION OF THE DRAWINGS

The invention is disclosed below according to its preferred embodiment, not at all limiting, and in reference to FIGS. 1 to 10, wherein:

FIG. 1 shows, according to a bottom view, an exemplary embodiment of a robot according to the invention, FIG. 1A shows the same type of effector on all the arms, and FIG. 1B shows different effectors on the arms;

FIG. 2 represents, according to front views, different embodiments of the robot of the invention, FIG. 2A shows a configuration on the ground, and FIG. 2B shows a configuration on the ceiling;

FIG. 3 illustrates, according to perspective views, the additive manufacturing principle of a part for an effector of the robot of the invention, FIG. 3A during one single rotation of the arm, FIG. 3B by stacking the elementary volumes of FIG. 3A and FIG. 3C according to a variant of the stack diagram of the volumes of FIG. 3A;

FIG. 4 illustrates the manufacturing of a part according to the principles represented in FIG. 3, FIG. 4A shows a perspective view for an individual effector, FIG. 4B shows a top view, the principle of determining manufacturing meshes from the digital model of the part and of the discretized manufacturing volume of the robot and FIG. 4C shows a perspective view, and in cross-section AA defined in FIG. 4B, of an exemplary embodiment of the part from its digital definition in FIG. 4B;

FIG. 5 shows a top view of an example of cooperation of several robots according to the invention, by comparing the tetragonal volume which can be reached by a robot in FIG. 5B and with the tetragonal volume which can be accessed by the association of robots in FIG. 5A;

FIG. 6 shows, according to a schematic top view, the association of 8 robots for the production of a part;

FIG. 7 illustrates a perspective view of an exemplary embodiment of a discharge hopper adaptable to an arm of the robot of the invention, FIG. 7A shows a cross-sectional view AA defined in FIG. 3A, and FIG. 7B shows a cross-section view BB defined in FIG. 7A;

FIG. 8 shows a top view of an embodiment of the robot of the invention using an additive manufacturing method by selective sintering or agglomeration of a material bed;

FIG. 9 shows a flowchart of the method of the invention; and

FIG. 10 schematically shows, according to a front view, a robot of the invention mounted on a mobile base.

### DETAILED DESCRIPTION OF THE EMBODIMENTS

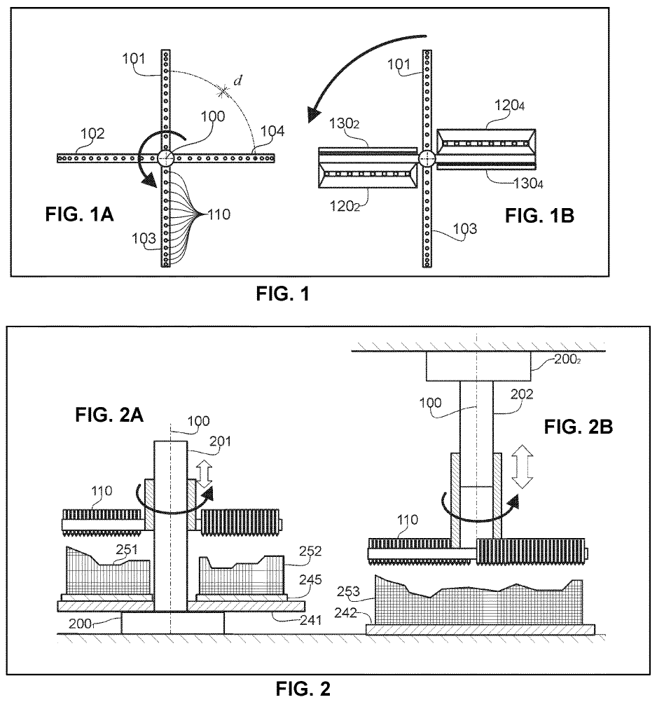

FIG. 1, according to schematic embodiment example, the robot of the invention comprises one or more arms (101, 102, 103, 104), preferably 4 arms, driven in rotation by suitable means about a central axis (100). Each arm includes one or more effectors (110) for additive manufacturing, radially distributed according to a step, even or not, on the arm.

According to exemplary embodiments, not all the arms include the same number of effectors, and the effectors are radially offset by a distance d, possibly variable along the arm, such that the combined action of the effectors covers the whole working volume of the robot in terms of additive manufacturing capacity.

According to an embodiment, the effectors can be radially moved, individually or in a group, along the arm.

To this end, an effector or a set of effectors is mounted on a motorized carriage on the arm. In the same way as for the radial offsetting of the effectors from one arm to the other, this arrangement, compatible with such a radial offsetting, allows to cover the working volume with a greater resolution.

According to embodiment examples, the length of the arms is comprised between 5 cm and 5 m. Thus, in its principle, the robot of the invention is adapted to a very wide range of parts.

The invention is applicable to the following additive manufacturing methods:

melting or sintering on a powder bed,

spraying of binder on a granular material,

spraying of material.

Thus, the device of the invention is adapted to the production of metal, polymer, ceramic or sand parts depending on the additive manufacturing method used.

According to the considered additive manufacturing method, the effectors are spray nozzles of a molten material, spray nozzles of a binder, a laser for the melting of a material, a device for depositing a non-agglomerated granular material or a scraper, in the form of a blade or a roller, to equal a deposited layer of granular material.

Additionally, certain effectors perform functions connected to the additive manufacturing operation, such as the spraying of a protective gas on the molten zone, or a gas able to accelerate the setting of the sprayed binder, or also a local heating function, for example by infrared radiation.

Thus, according to an exemplary embodiment, FIG. 1B, two of the arms are provided with a multi-hole hopper (12θ₂, 12θ₄) for discharging a granular material, and a scraper (13θ₂, 13θ₄) to equal the deposited layer of material, and the two other arms (101, 103) are provided with effectors to selectively agglomerate, by melting or by binding, the deposited layer of material.

One of the arms (101) selectively agglomerates the layer of material deposited by one of the hopper and scraper assembly (12θ₂, 13θ₂) and the other arm (103) selectively agglomerates the layer of material deposited by the other hopper and scraper assembly (12θ₄, 13θ₄).

FIG. 2, in addition to the rotational movement, for the production of a part (251, 252, 253), the arms are guided and moved vertically at a controlled speed parallel to their axis (100) of rotation, which is schematically represented by a guiding shaft (201, 202) in FIG. 2. According to these examples, the guiding shaft (201, 202) and by way of consequence all of the manufacturing means of the robot are mounted on a base (20θ₁, 20θ₂).

FIGS. 2A and 2B to simplify the representation, the part (251, 252, 253) is made by a material spraying method. In the case where the part is produced by selective agglomeration or sintering of a material bed, said part is located in the material bed and the device comprises means for retaining said material bed, as represented in FIG. 8.

FIG. 2A, according to a first embodiment, the base (20θ₁) supporting the shaft (201) is placed on the ground, the part or the plurality of parts (251, 252) is produced by additive manufacturing on a table (241) extending around the guiding shaft (201). This embodiment is simpler and less expensive in terms of manufacturing the robot. However, the central zone, inhabited by the shaft, limits the volume of the parts that can be produced.

FIG. 2B, according to another embodiment, the base (2002) supporting the shaft (202) is placed on the ceiling. In this embodiment, it is possible to place effectors (110) close to the center of rotation of the arms, and the working volume as well as the functional surface of the table (242) are not limited by the presence of the shaft (202). For a robot exhibiting the same working volume, the parts that can be produced (253) are larger, comparatively to the solution of FIG. 2A.

The robot of the invention can be used in all its embodiments for 2.5D or 3D manufacturing.

Preferably, in both cases, during additive manufacturing, the arms rotate at a constant speed.

In 2.5D, the part is produced by successive planes perpendicular to the axis of rotation. The additive manufacturing operation is carried out in a plane, by one or more rotations of the arms at a constant altitude, then the arms are moved parallel to the axis of rotation of an increment and a new additive manufacturing phase is carried out in a plane parallel to the preceding one, and so on. This solution involves stopping the additive manufacturing process: melting, agglomerating, spraying, and possibly depositing a material layer, between two increments, even if the arms continue to rotate.

In 3D, the rotary movements of the arms and their axial movement along their axis of rotation are combined such that each effector follows a helical path, of variable step according to one particular embodiment. According to this embodiment, the additive manufacturing process is continuous, and productivity is higher.

In addition, this embodiment allows to simplify the manufacturing of the robot of the invention, by only using one single drive motor for rotation of the arms, the latter thus moving vertically by way of an helical guiding along the shaft.

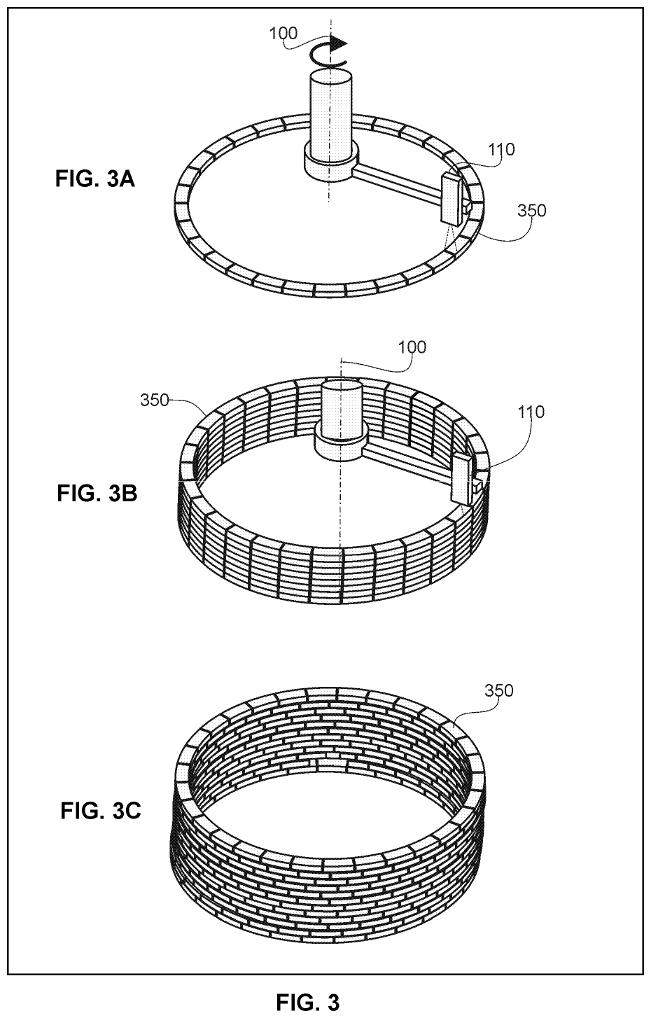

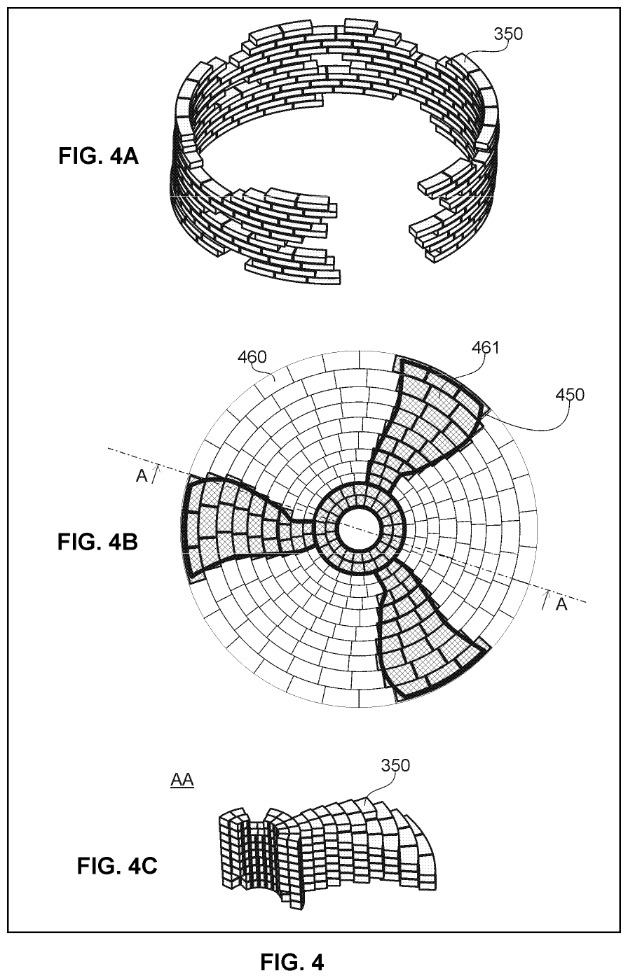

FIGS. 3 and 4 schematically illustrate the process of manufacturing a part by means of the robot of the invention. To read these figures, the process represented is a 2.5D manufacturing process and the voxels are represented in a much greater dimension with regard to the part produced, then they are in reality. The passage to a 3D manufacturing configuration is easy by considering meshes (450, 451) and voxels (350) in the helical portion.

The motions, likewise the activation/deactivation of the effectors are controlled by a numerical control director (not represented). The device includes sensors, such that the position of the arm, both angular and elevation on its axis of rotation is known at any time. The positions of the effectors on the arm, both radially and elevation are also known and entered in the tables of the numerical control director, such that the position in space of the material sprayed or agglomerated by the effector is also known at any time by the numerical control director.

FIG. 3A, the arm being driven in rotation about its axis (100), each effector (110) installed on said arm follows a circular path (helical in the case of a 3D process). The activation of the additive manufacturing effector, i.e. the activation of the spraying of material by this effector, or the spraying of a binder in the case of agglomerating a granular material, or the triggering of the emission of the laser source of the effector for the melting or the sintering of the material, during a determined time/motion, produces an elementary volume of material (350) or voxel.

The smallest volume of material which can be produced, depends, for a given method, or the minimum activation-deactivation-reactivation time of the effector and of the motion speed of the effector relative to the part, the latter being a function of the angular speed of the arm and of the radial position of the effector on the arm.

Thus, in this embodiment example, non-limiting, in 2.5D, each effector is able to produce a voxel ring (350) during a rotation of the arm.

FIG. 3B, the repetition of this operation at different elevations confers to each effector (110), the capacity to produce a cylindrical, tubular volume by stacking the voxels (350).

FIG. 3C, according to an exemplary embodiment, the voxels are not directly stacked on one another, as shown in FIG. 3A, but are stacked in staggered rows or according to any other pattern from one plane to the other.

In any case, the volume of material potentially agglomerated, sprayed or sintered by an effector is located in a circular, tubular volume, and the position as well as the dimension of each voxel depends on the activation and deactivation positions of the effector.

FIG. 4A, during the motion of the arm, each effector is activated/deactivated as a function of the contour to be made, so as to produce a portion of its potential tubular volume.

Thus, by associating several effectors such that their tubular manufacturing volumes are contiguous or overlap, the manufacturing volume is a cylinder discretized into elementary volumes.

FIG. 4B, from a digital standpoint, this manufacturing volume is discretized into volumetric meshes (460), corresponding to all the voxels which can be produced by each effector in this volume.

FIG. 4B, according to an exemplary embodiment of a helical-shaped part represented as a top view to simplify the image, the volumetric digital model of the part (450) is placed in this discretized volume also in digital form.

Through a suitable digital processing, the meshes (461) of the manufacturing volume which are located in, or which approximately define the volume of the model (450) of the part, as a function of a defined projection tolerance, will correspond to voxels made during the additive manufacturing operation. This digital operation of selecting meshes (461) is relatively simple to produce by a volumetric digital design software.

In the case of FIG. 4B, the mesh has been optimized to consider the possibility of angularly offsetting the voxels made, from one effector to the other and also from one plane to the other. This operation is very easily performed from a digital standpoint, for example by the rotation of each mesh ring (460) in each plane of elevation so as to best follow the contour of the digital model (450).

FIG. 4C, the part is made by stacking the voxels (350) corresponding to the meshes (461) identified during the digital processing.

Comparatively to the technique of the prior art which requires the definition of paths, the passage from the digital processing to that of the manufacturing is also simplified in the case of the robot of the invention.

As a for instance, the production of the part shown in FIG. 4 by conventional techniques, requires the production of paths about 3 axes of the application/agglomeration point of the material on the part. The production of these paths by the machine or the robot is conveyed by combinations of movements about the axes of articulation or movement of the machine or of the robot, with the necessity at the level of its numerical control director, to determine these movements by inverse kinematics regarding the programmed path.

Physically, during manufacture, following these paths on the means of the prior art is conveyed by permanent accelerations/decelerations on the axes of motion or articulation of the machine or of the robot, although the path of the application/agglomeration point on the part are traveled at a substantially constant speed by the kinematic combination of these movements.

In the case of the device of the invention, in its simplest implementation, only two axes of motion of the effectors are used, the rotation of the arm and its vertical movement along its axes of rotation, and these two movements are made at constant speeds, and according to a simplified embodiment example, driven by one single motor. There is no path programming, the part is produced by activation/deactivation of the effectors in given positions, corresponding directly to the meshes (461) identified during the digital processing.

The activation/deactivation according to the position of the effectors is an all-or-nothing function, which does not require any inverse kinematics for it to be performed. A modern numerical control director is potentially able to control a number of these effectors well beyond all that is necessary for the implementation of the manufacturing method by the device\of the invention.

The implementation of effectors which can move along the arm of a step of variable movement parallel to the axis of rotation of the arm, are improvements mainly aiming to increase the manufacturing resolution of the device of the invention. These are easily considered at the digital level in the definition of the mesh allowing the programming of the part, and broadly enter into the controlling capacities of the numerical control director.

Contrary to what FIGS. 3 and 4 could convey, the device of the invention and its implementation, are absolutely not limited to the production of revolving parts. Any part shape can be made as soon as its volume enters into the manufacturing volume of the considered device.

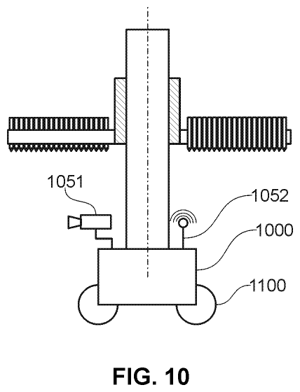

FIG. 10, according to one embodiment, the base (1000) is provided with motion means (1100). According to this example, the robot is placed on a carriage provided with wheels or tracks to move in a defined space, for example in a workshop or in a structure during the manufacture of parts such as a boat hull, an aircraft fuselage or a civil engineering structure.

Advantageously, each robot mounted on its carriage comprises allothetic or idiothetic positioning means (1051, 1052), absolute or relative, both in its environment or relative to another robot, by triangulation of positioning beacons, processing of video, lidar images, or measuring on its motricity means, individually or in combination.

Thus, a plurality of such robots, becomes a plurality of cobots able to be associated in a greater or lesser number as needed. The cobots are thus able to intervene according to several successive association diagrams, possibly on floors at different heights, in order to create a very large structure.

The manufacturing of a part by the association of several cobots of this type is preferably made in 2.5D to simplify collision avoidance.

Alternatively, the mobile base is mounted on the ceiling, for example suspended on a rail network covering the targeted working space.

Alternatively also, the mobile base is supported by a cable robot.

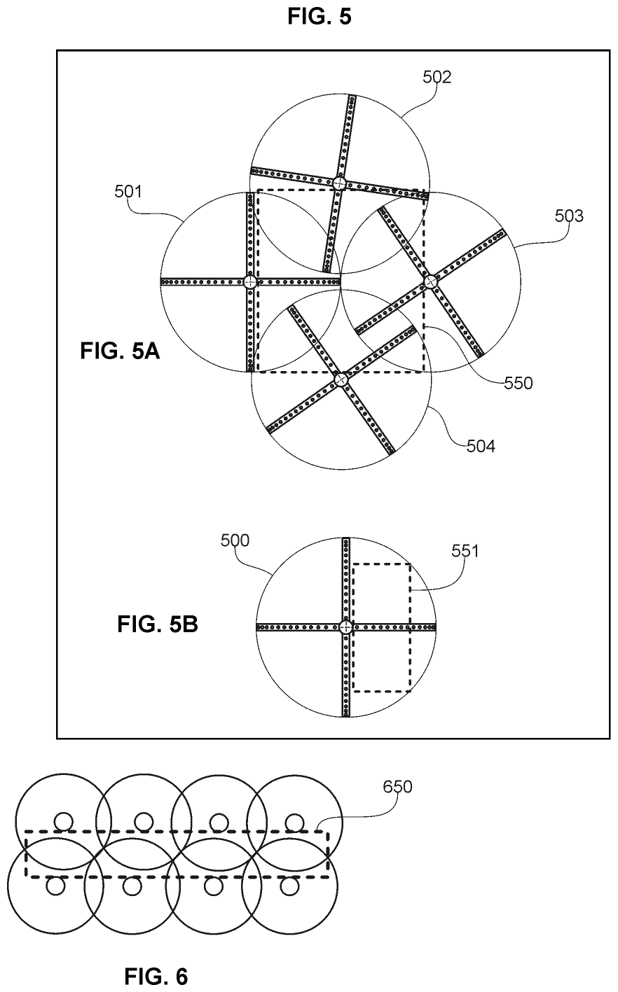

FIG. 5, the manufacturing volumes of several robots can be combined so as to obtain a total manufacturing volume which is a lot greater.

Thus, FIG. 5A according to a combination example, 4 robots (501, 502, 503, 504) are combined such that their working volumes overlap. The overlaps are more or less significant according to the shape of the part to be produced and the targeted resolution. Thus, according to this non-limiting schematic example, the paths of the ends of the arms of two of the robots (501, 503) are tangent, but these could very well be intersecting in order to best cover the central part. This is the same for the two other robots of this example (502, 504).

The position and the speed of rotation of the arms of each robot are synchronized so as to avoid any collision.

According to this non-limiting embodiment example, the robots are of the “placed on the ground” type and their individual working volume comprises a non-accessible central zone corresponding to the position of the guiding shaft.

Thus, FIG. 5B, the perimeter (551) of the maximum tetragonal volume achievable in one piece with such a robot (500) comprising a central shaft, is limited by the presence of this central shaft.

Returning to FIG. 5A, the combination of 4 robots of the same type as shown in FIG. 5B, allows to reach a tetragonal volume of production, the perimeter (550) of which is twice as large, that is the volume is 4 times larger, compared with that of one single robot.

The association of several robots of the invention is not limited to robots placed on the ground and works just as well with robots mounted on the ceiling.

FIG. 6, potentially, it is thus possible to combine the working volumes of any number of cobots according to multiple arrangements to cover a desired manufacturing volume (650).

To this end, each cobot is advantageously equipped with proximity, contact, alignment and positioning sensors, for example able to interact with radio or ultrasound beacons, so as to be positioned against one another, and wired or radioelectric communication means so as to create between them, a network comprising a master-slave relationship, for the synchronization of their actions.

The programming of the cobots thus associated benefits from all the advantages indicated above for the individual programming of a robot of the invention.

Returning to FIG. 2, according to an embodiment, the part (251, 252, 253) is mobile during production relative to the axis (100) of rotation of the robot. To this end, FIG. 2A, according to an embodiment example adapted to the case of a robot, the shaft (201) of which is placed on the ground, the table (241) comprises one or more carriages (245) which can be moved relative to the table by devices such as ball screws or linear motors controlled by the numerical control director of the machine.

In the case, FIG. 2B, of a robot, the shaft (202) of which is mounted on the ceiling, the table (242) is itself coupled with controlled motion means.

According to an embodiment of the motions of the table (242) or carriages (245) thus enabled are linear motions in a plane perpendicular to the axis of rotation (100) of the arms, for example in orthogonal directions.

One same result is obtained by using a fixed table and a robot, the base of which is provided with motion means (FIG. 10).

According to another embodiment, compatible with the preceding one, the motions of the table (242) or of the carriage (245) comprise angular orientations about a parallel axis or an axis perpendicular to the axis of rotation of the arms.

These embodiments allow to increase the production resolution of the robot and to increase the volume of the parts which can be produced.

Returning to FIG. 1B, for the implementation of an additive manufacturing method by selective agglomeration or sintering, one of the arms (102, 104) of the robot is advantageously provided with a discharge hopper (12θ₂, 12θ₄) to deposit successive layers subjected to agglomeration or to sintering.

This embodiment can be used both in 2.5D manufacturing and in 3D manufacturing.

The hopper is advantageously a hopper with multiple holes which, associated with scraping means, allows the deposition of a layer of material of uniform thickness in the kinematic configuration of the arm.

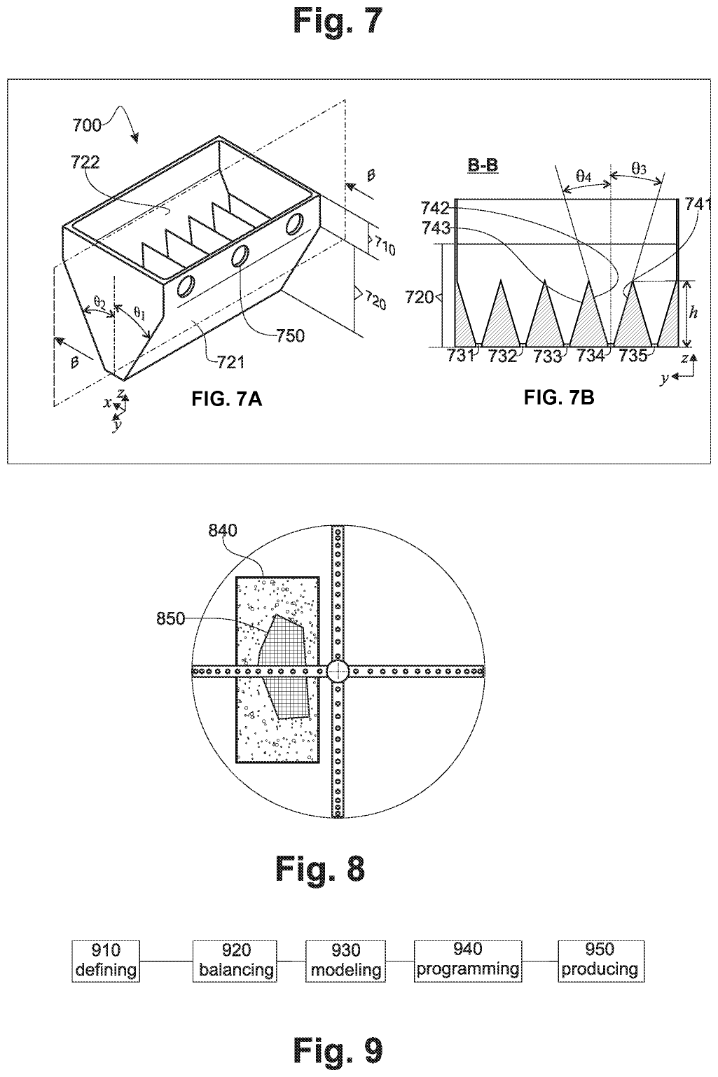

FIG. 7, according to an embodiment example, the hopper (700) adaptable on an arm of the robot of the invention comprises an upper part (710) and a lower part (720) called discharging part comprising two inclined walls (721, 722) converging towards the multiple lower openings, distributed in a transverse direction (y).

The hopper (700) comprises in its upper part, means (750) for attaching it to an arm of the robot, in particular by bolting.

The two inclined walls (721, 722) of the lower part (320) of the hopper are symmetrically inclined facing a transverse vertical plane (x, y) by an angle θ₁=θ₂. These angles (θ₁, θ₂) are, in any case, less than 40° and preferably less than 30°, such that the angle of the discharge cone (θ₁+θ₂) between the two inclined transverse walls (721, 722) of the lower part, is at most, equal to 80° and preferably less than 60°.

FIG. 3B, the hopper (700) is divided into its lower part (720). Each compartment corresponds to a hole (731, 732, 733, 734, 735), the hopper comprising several holes aligned in the transverse direction (y). Each compartment constitutes a conic hopper of evolving rectangular cross-section in the discharging part (720) of the hopper. This “sub-hopper” facing each hole is delimited in the longitudinal direction (x) by the inclined walls (721, 722) of the hopper and in the transverse direction (y) by the dividing walls (741, 742), inclined relative to a longitudinal vertical plane (x, z) and converging towards a hole.

Each dividing wall is inclined by an angle (θ₃, θ₄) less than 40°, preferably less than 30°, such that the opening angle (θ₃+θ₄) between two dividing walls leading to a hole, is at most equal to 80° and preferably less than 60°. The conduit is thus created between the inclined walls and the dividing walls down to the outlet of the hopper, comprising no surface inclined by an angle greater than 40° relative to the vertical direction. These conditions ensure a fluid flow of the granular material contained in the hopper (700), in the form of a mass flow, towards each of the holes (731, 732, 733, 734, 735) of the hopper.

The geometry of the compartments bringing the material towards the holes, is such that the actual flow cross-section through a hole is equal or substantially equal to the cross-section of the hole during almost all of the emptying time of the hopper.

These conditions allow to obtain an almost constant discharge flow through each of the holes, this flow being fixed by the nature of the discharged material, in particular its volumetric mass and its grain size and the geometry of the hopper, i.e. without needing specific means for controlling the discharge flow.

The contiguous dividing walls (742, 743) of two successive compartments are connected together, in the lower part (720) of the hopper, by a sharp connection, said walls thus connected forming a tooth or a wedge, with a point angle less than 60°, preferably less than 40°, according to the respective inclination of the surfaces (742, 743) thus connected. This characteristic ensures an easy separation of the flows towards the multiple holes of the hopper.

The opening cross-section of the holes is advantageously different in the transverse direction.

Thus, during the rotation of the arm, the hole (731) with a smaller opening follows a circular path closer to the curvature center and consequently in a smaller radius, while the hole with a larger opening (735) follows a path farther away from the curvature center and of a larger radius.

The material is deposited in strips facing each hole and distributed on the surface of the material bed by a scraper also attached to the arm of the robot (FIG. 1B).

FIG. 8, the use of the robot of the invention for the implementation of an additive manufacturing method using a selectively agglomerated or sintered material bed, requires a retention container to contain said material bed. Advantageously, according to an embodiment of the robot of the invention, the means (840) for retaining the material bed are created in the material itself, by sintering or agglomeration at the same time than the part (850) is produced.

FIG. 9, according to an embodiment example of the method of the invention, this comprises two digital steps (910, 920).

During a step (910) of defining the working volume, the working volume discretized into volumetric meshes, of the robot or of a plurality of associated robots is defined. The volumetric meshes correspond, for example, to the smallest voxels which can be produced by each of the effectors carried by the robot or the plurality of robots.

During a balancing step (920), the digital model of the part to be produced is positioned in the discretized volume determined in the preceding step (910).

During a modeling step (930), the elementary volumetric meshes comprised in the volume of the digital model and those of which the edges follow the contour of said model according to a predefined projection tolerance are determined.

During a programming step (940), each volumetric mesh determined during the modeling step (930) and corresponding either to the part produced or to the creation of a retention means of a material bed, is translated into a spatial activation and deactivation position of each of the effectors.

According to one step (950), the part is produced by stacking voxels from the obtained program.

The description above and the embodiment examples, show that the invention achieves the targeted aim, in particular it allows a greater productivity and a simpler programming of the additive manufacturing operations compared with conventional kinematic solutions. The manufacturing of the robot is also cheaper at equal working volume. The robot of the invention can be produced in a wide range of dimensions and is adapted to the implementation of several additive manufacturing methods. The possibility of making several robots cooperate allows the production of very large parts, such as naval or aeronautical structures, tools or civil engineering constructions. At the extreme opposite end of the scale, according to additive manufacturing technology, the density of effectors along an arm can reach 25 effectors per millimeter and thus provide a high production resolution on small parts.

1-11. (canceled)

12. A robot configured to manufacture a part by additive manufacturing by volume elements or voxels, the robot comprising: a base; a rotary arm comprising a plurality of effectors for additive manufacturing radially distributed on the rotary arm;
a guiding shaft to translationally move the rotary arm, in a direction parallel to its axis of rotation and to rotationally move the rotary arm relative to the base; a controller to control an action of the effectors for additive manufacturing as a function of a position of the rotary arm in space.

13. The robot of claim 12, further comprising a plurality of rotary arms.

14. The robot of claim 13 configured to implement an additive manufacturing method by a selective aggregation of a granular material comprised in a material bed, wherein one of the plurality of rotary arms comprises a deposition assembly of the granular material on the material bed.

15. The robot of claim 14, wherein the deposition assembly comprises a deposition hopper comprising a plurality of discharge holes.

16. The robot of claim 15, further comprising a scraper acting on the material bed, driven by one of the plurality of rotary arms.

17. The robot of claim 12, further comprising a part support to support and move the part during manufacturing.

18. The robot of claim 12, further comprising a motorized carriage to move the plurality of effectors along the rotary arm.

19. The robot of claim 12, wherein the base comprises a carriage to move the robot in space.

20. A method for additive manufacturing of the part implementing the robot of claim 12, comprising steps of: (i) obtaining a volume discretized into volumetric meshes corresponding to a manufacturing volume of the robot; (ii) inserting a digital model of the part in the volume obtained in step i); (iii) determining the volumetric meshes comprised in the volume of the digital model and delimiting contours of the digital model according to a predefined projection tolerance; (iv) producing the part by associating with each volumetric mesh determined in step iii) with an activation of an effector in a corresponding position.

21. The method of claim 20, further comprising selective sintering or agglomerating of a material bed; and wherein the activation of the effector in step iv) produces a retainer to retain the material bed.

22. The method of claim 20, wherein the base comprises a carriage to move the robot in space; wherein step iv) further comprises an association of a plurality of cooperating robots to increase the manufacturing volume; and wherein step i) further comprises the obtaining of a total manufacturing volume of all robots combined.
